(19) United States
(12) Patent Application Publication
(10) Pub. No.: US 2015/0154561 A1
(43) Pub. Date: Jun. 4, 2015

(54) DYNAMIC APPLICATION PERSONALIZATION ENGINE FOR ENTERPRISE SOFTWARE

(71) Applicant: Kevin KRAMER, San Francisco, CA (US)

(72) Inventor: Kevin KRAMER, San Francisco, CA (US)

(21) Appl. No.: 14/547,129

(22) Filed: Nov. 18, 2014

Related U.S. Application Data
(60) Provisional application No. 61/905,295, filed on Nov. 18, 2013.

(51) Int. Cl. G06Q 10/10; G06F 3/0482; G06F 3/0481

(52) U.S. Cl. CPC G06Q 10/10; G06F 3/04817; G06F 3/0482

(57) ABSTRACT

The techniques described herein provide personalized user interfaces and data filters for users of a CRM system using dynamic attributes. In one embodiment, the user interfaces make it easier for users to find the child objects of a parent object without having to continually go back to the main page of the parent. For example, a salesperson may need to view opportunities, contacts or cases related to a single account, and move from one opportunity to another as efficiently as possible. In another embodiment, the user interfaces aggregate data for a summary view of distributed data, while also allowing efficient drill down to list views. For example, a manager can quickly gain access to all accounts, opportunities, contacts or cases that are owned by a sales team member or representative, their entire team as a whole, or those owned by a subset of their team. In yet another embodiment, data is aggregated and sales intelligence is generated based on dynamic attributes. In still another embodiment, data is aggregated in accordance with a corporate hierarchy.

### CROSS REFERENCE TO RELATED APPLICATION

This application claims priority of U.S. Provisional Application No. 61/905,295, filed Nov. 18, 2014 entitled DYNAMIC APPLICATION PERSONALIZATION ENGINE AND INTELLIGENT DATA AGGREGATOR FOR ENTERPRISE SOFTWARE, the contents of which are hereby incorporated in its entirety.

### FIELD OF THE INVENTION

The invention relates generally to computer software and databases, and more specifically, to personalization of view, report and navigation of objects in a (customer relationship management) application, such as an SFA (sales force automation) application.

### BACKGROUND

Enterprise software applications can be a collection of computer programs with a common purpose for serving organizations such as business entities or institutions. In the field of sales, CRM or SFA are types of enterprise software used to power sales teams. These systems can be used to track sales opportunities, leads, contacts, management and other customer interaction functions.

Traditional CRM systems, such as Salesforce.com, can be difficult to navigate and aggregate the information needed by sales reps and management. While objects owned by a user are relatively easy to find in these systems, only a small portion of the users in an enterprise sales organization are individual sales reps that typically own objects. Consequently, managers reviewing sales team data, an engineer supporting a sales person, lead generation inside sales representatives, channel sales teams, and the like, have more difficulty in generating views for objects they do not own. These users often end up creating their own supporting infrastructure of reports and views that contain hard-coded filter values based on the desired owner's name. Traditional systems often secure access to data through security controls, but in those controls there is usually a little bit of room for error and most users are allowed to see more than they want to see. This means that just because a user is allowed to see some data, they may not want or need to see that data to do their job. Access or having visibility to data is not sufficient for personalization of data based on the market coverage responsibility for most users.

Navigation can also be time consuming and difficult. Users essentially navigate down a node tree of objects and, in order to view a peer-level sister or cousin object, are forced to return to the top of the node tree and navigate down a new path of the node tree to view the peer object. Attributes of the peer objects that match objects currently viewed in user interface are not typically used to help users navigate quickly between peer objects.

Moreover, it is also difficult to generate a list of all child objects that are related to an account for quick and efficient updates without making multiple clicks and waiting for several different pages to load before the user can make a change to one of these objects at a time.

What is needed is a robust technique for personalization of CRM user interfaces for faster, more efficient, and more personalized and tailored interactions.

### SUMMARY

To meet the above-described needs, methods, computer program products, and systems for CRM personalization. The techniques described herein provide personalized user interfaces and data filters for users of a CRM system using dynamic attributes.

In one embodiment, a personalization engine makes drilling down easier for users to edit the child objects of a parent object (e.g., representing an account) without having to continually go back to the main page of the parent. Icons are provided for different types of child objects at a top level that direct the user to a screen in which different child objects can be quickly edited.

In another embodiment, the personalization engine makes account coverage easier for users. Whether or not a manager owns objects, they can be viewed from different perspectives. For example, a manager may need to view opportunities, contacts or cases as owned by a specific representative, and move to a different view of objects owned by a second representative or a group of representatives.

Advantageously, CRM interaction is more efficient, faster, and more effective.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a CRM personalization system, according to one embodiment.

FIG. 2 is a more detailed block diagram illustrating a CRM application server of FIG. 1, according to one embodiment.

FIG. 3A is a high-level flow chart illustrating a method for CRM personalization, according to one embodiment.

FIG. 3B is a more detailed block diagram illustrating a method for setting attributes and then filtering based on dynamic attributes based on context, according to one embodiment.

FIG. 3C is a block diagram illustrating an exemplary method for drill down techniques.

FIG. 3D is a block diagram illustrating an exemplary method for coverage techniques.

FIG. 4A is a block diagram illustrating relationships between a user and objects, according to prior art.

FIG. 4B is a block diagram illustrating account drill-down from a user, according to one embodiment.

FIG. 4C is a block diagram illustrating a non-existing relationship between some users (overlays) and the user owned objects, according to prior art.

FIG. 4D is a block diagram illustrating multiple objects owned by a single user that need to be grouped together for viewing, according to prior art.

FIG. 4E is a block diagram illustrating coverage drill-down from a user, according to one embodiment.

FIG. 4F is a block diagram illustrating an example of data that is distributed across objects for an account, according to prior art.

FIG. 4G is a block diagram illustrating an example of aggregating and interpreting the aggregating distributed data of FIG. 4F, according to one embodiment.

FIG. 4H is a block diagram illustrating an example of how each account will have a different aggregation and interpretation of distributed data, according to one embodiment.

FIG. 4I is a block diagram illustrating an example of account parents for aggregated data and a family parent for aggregated account parents, according to one embodiment.

FIG. 5 is a schematic diagram illustrating an example of coverage in action, according to one embodiment.

FIG. 6A is schematic diagram illustrating an example of drill down for an account, according to one embodiment.

FIG. 6B is a schematic diagram illustrating an example of coverage drill down for a manager, according to one embodiment.

FIG. 7 is a block diagram illustrating a general computer system for implementing techniques described herein, according to one embodiment.

### DETAILED DESCRIPTION

Methods, computer program products, and systems for dynamic personalization and filtering of screens of a CRM (customer relationship management) database system are described herein.

I. Systems Dynamically Personalize and Filter Screens

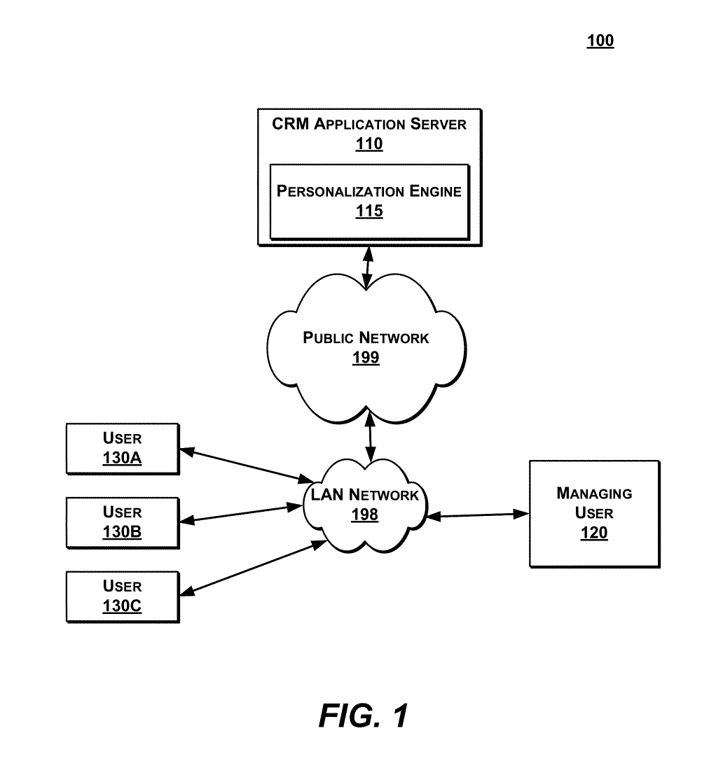

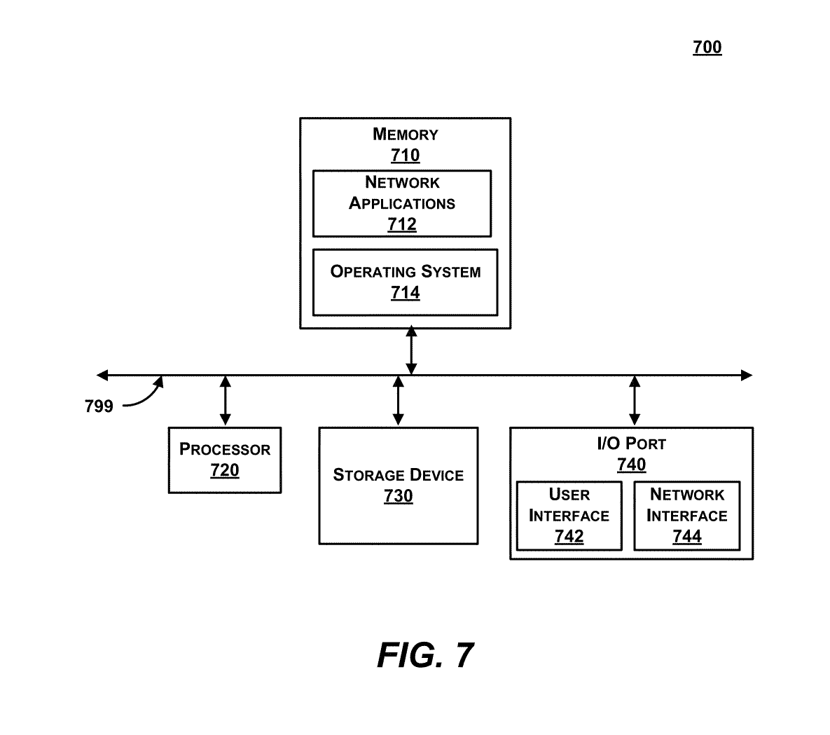

FIG. 1 is a high-level block diagram illustrating a CRM personalization database system 100, according to one embodiment. The CRM personalization system 100 includes a CRM application server 110 coupled to a public network 199 and in communication with a LAN network 198 coupled to a managing user (i.e., computing device used by a manager) 120 and users (i.e., computing device used by users) 130A-C. The components can be implemented in a computing device such as the embodiment shown in FIG. 7. One of ordinary skill in the art will recognize that various alternative architectures can implement the techniques described herein.

The CRM application server 110 stores database records for a sales company having existing and potential customers. Natively, a top level view for a user logging on serves as an index that leads to lower level views until an object level view is reached which allows editing of a particular object. Representatives (e.g., user 130A) of the sales company can own objects that represent an account, either existing or potential. A representative has primary responsibility for an account, although the account can be sectored (e.g., Company X—computing and Company X—online services). When a representative logs on to the CRM application server 110, all objects owned by that representative are available to be shown on a user interface screen. Managers or overlays that can be higher up the organizational hierarchy than representatives do not need to own any objects because there is no direct responsibility, although some objects may be owned in some implementations. When a manager or overlay (e.g., managing user 120) having oversight of representatives logs on, the native configuration of the CRM application 110 can be to show all objects owned by all representatives, all objects owned by the manager or overlay, or all objects shown under a security access granted to the manager or overlay.

A personalization engine of the CRM application server 110 personalizes, for example, the native configurations, views, reports, and navigation for a user of the CRM. The personalization can take place in real-time, in an embodiment, by writing a value to personalization settings that is based on items currently on the screen. When an icon or other link is selected, the resulting view is modified from a native behavior due to the updated personalization settings. More details are given below.

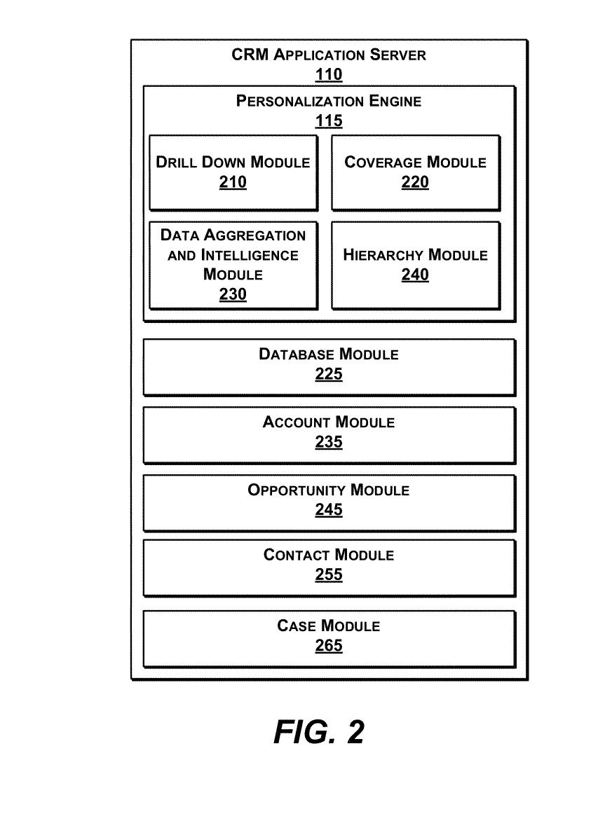

The CRM application server 110 can be, for example, an SFA (sales force automation) server as distributed by salesforce.com of San Francisco, Calif. Other implementations to CRM systems and other types of databases are possible. Further, the personalization engine 115 can be a third party plug-in, a software patch, or fully integrated into an off-the-shelf version of the database system 100. The CRM application server 110 is described in more detail below with respect to FIG. 2.

A corporation or other type of entity can operate the LAN network 198 to for access to the CRM application server 110 by the managing user 120 and the users 130A-C. For example, a sales manager and sales team can track operations using enterprise such as Salesforce.com or the like.

FIG. 2 is a more detailed block diagram illustrating the CRM application server 110 of FIG. 1, according to one embodiment. The CRM application server 110 includes the personalization engine 115 along with conventional components shown (i.e., database module 225, account module 235, opportunity module 245, contact module 255 and case module 265) and conventional components not shown (e.g., security and access module, forecasting module, reporting module and analytics module).

The personalization engine 115 determines dynamic attributes in order to generate user interfaces for navigation through data of the CRM. In further detail, the drill down module 210 exposes functionality (e.g. editing) at a top level view that is natively available after navigating screens to an object level view. The coverage feature 220 personalizes and filters views of objects that are not directly owned. For example, a manager can view objects from the perspective of a certain representative. The data aggregation and intelligence module In other embodiments, other optimizations of database system 100 are possible (e.g., aggregation of data).

The database module 225 stores records for accounts such as sales accounts owned by representatives. The account module 235 implements rules to manage the account records. The opportunity module 245 allows users to organize and process opportunities for a particular account. The contact module 255 allows tracking of specific personnel from an account. Finally, the case module 265 permits coordination of different customer service issues that occur for an account.

A. Coverage and Drill Down

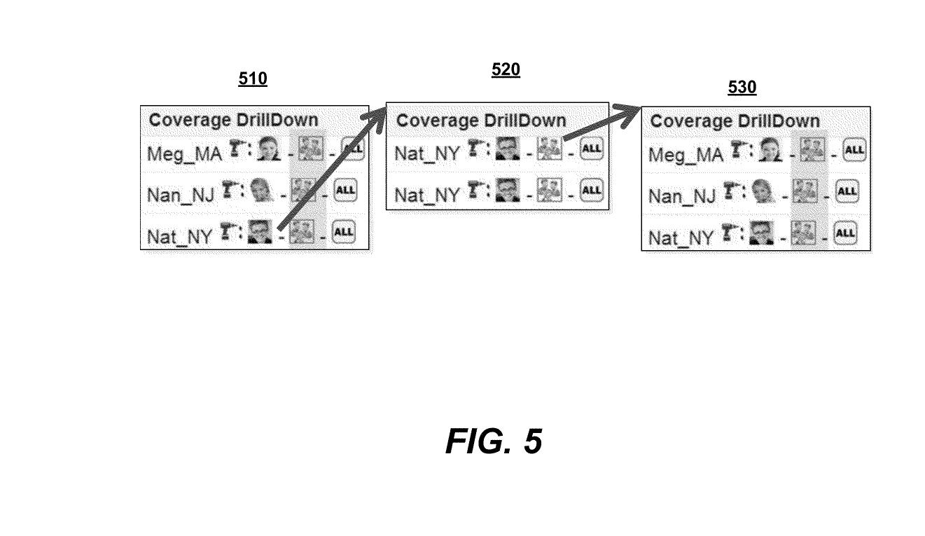

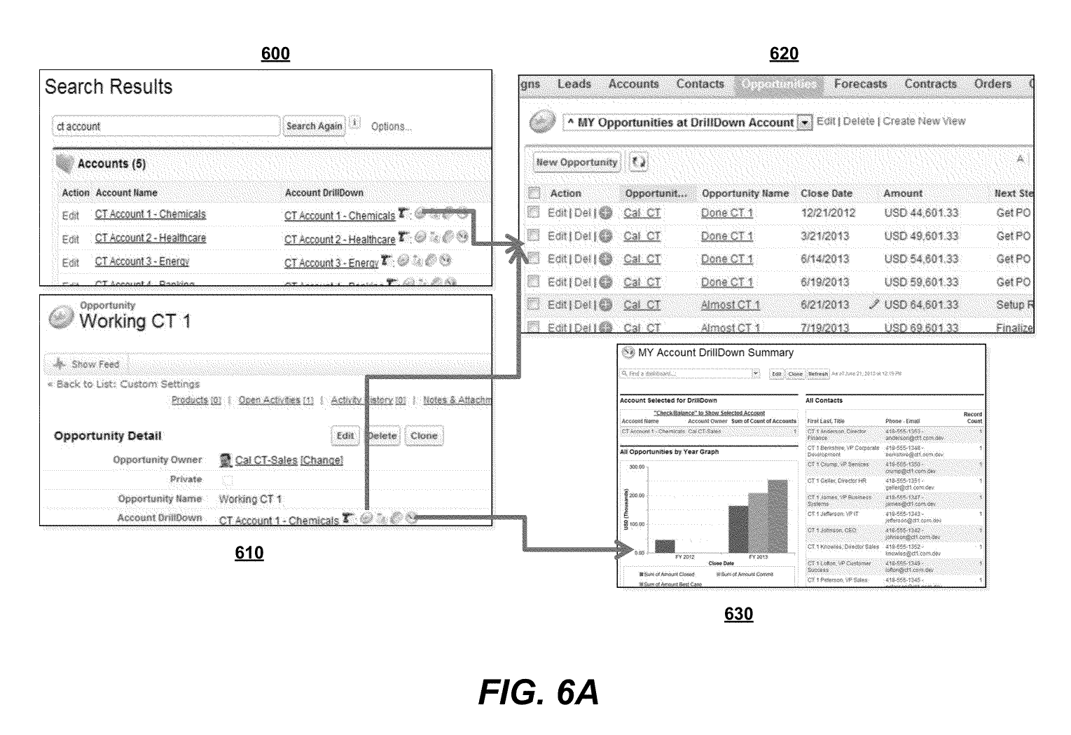

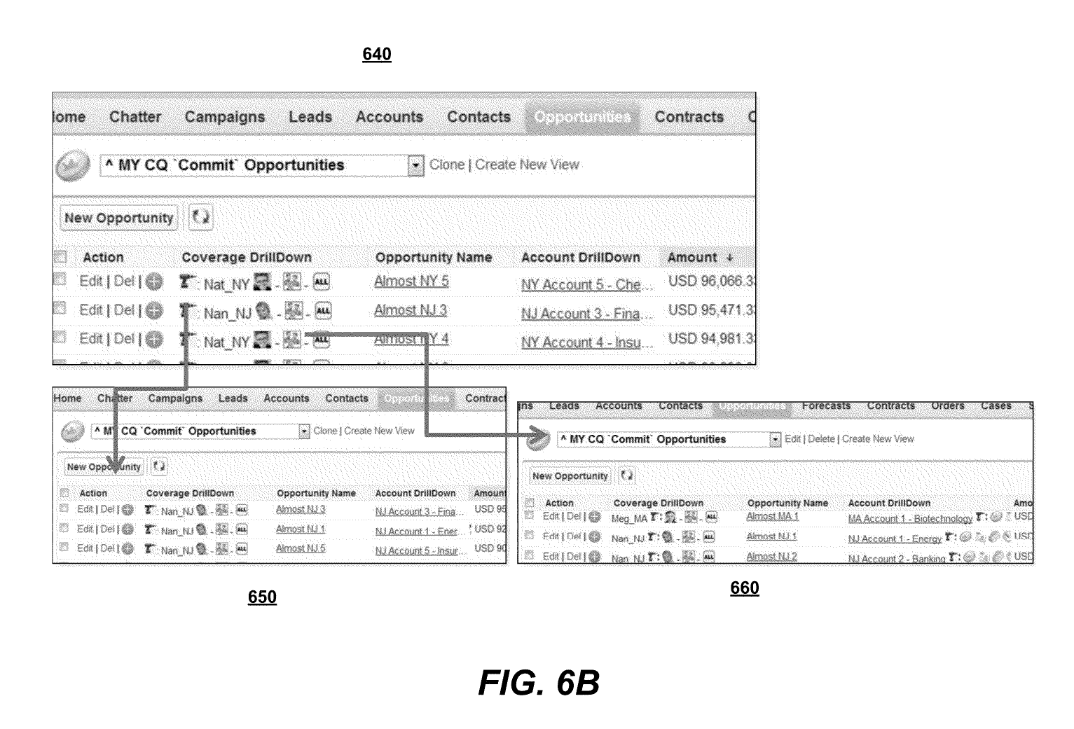

In one embodiment, user-managed attributes and current attributes of an object are used to dynamically control filtering of other objects. The filtering can be based on the attributes of an owner of a record. The filtering can also be based on a relationship of a record to other records. In more detail, reports, dashboards and views affect the coverage filters generated for an overlay or manager. An example of coverage is shown and the icons for coverage drill down access are shown in FIG. 5 with respect to a set of icons shown in screenshot 510 when Nat_NY is selected, an individual representative shown in screenshot 520, a group of representatives shown in screenshot 530 when that icon is selected. Another example is shown in FIG. 6A with respect to an account (screenshot 600 and screenshot 619 directly leading to editable screenshot 620 or screenshot 630), and in FIG. 6B with respect to a manager picking one owner to drill into (screenshot 640 leading directly to editable screenshot 650 or 660).

In another embodiment, user-managed attributes are adjusted to instantly (in real-time) to control filtering of other records. Clicks are reduced 50% or more by providing one-click access to a list view that is enabled to perform in-line editing as opposed to requiring navigation to each individual record to make updates.

In an additional embodiment, an aggregated and guided navigation allows users to view collections of records based on ownership or other record relationships. A single report, view, or dashboard, to show each user relevant data regardless of role. As a result, a manager can run reports for a sales team without being the owner of records or objects. An operations professional can create a single report, view, or dashboard that will run for each user in the organization regardless of role.

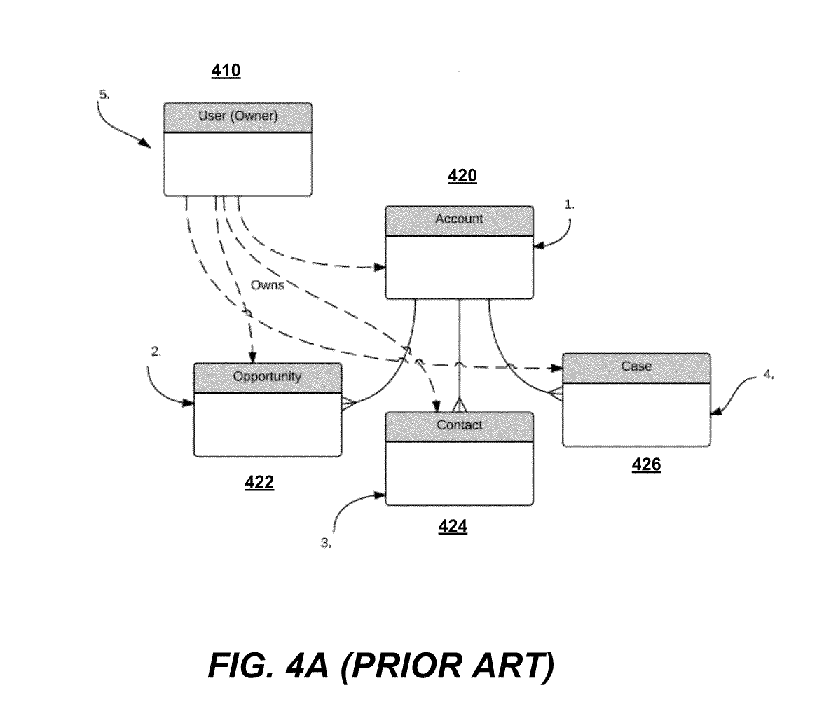

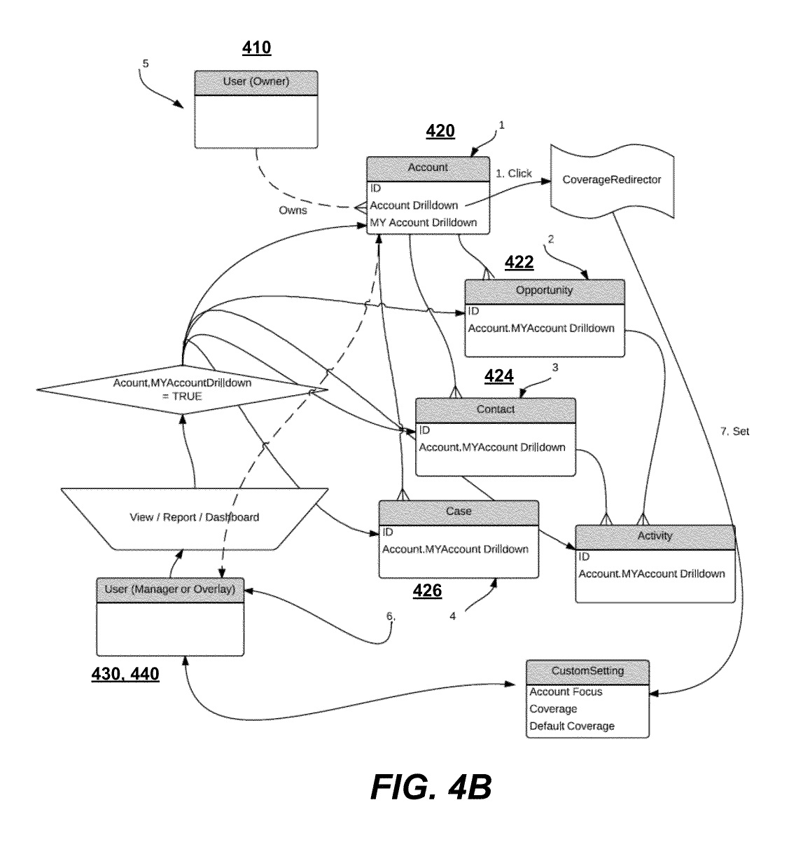

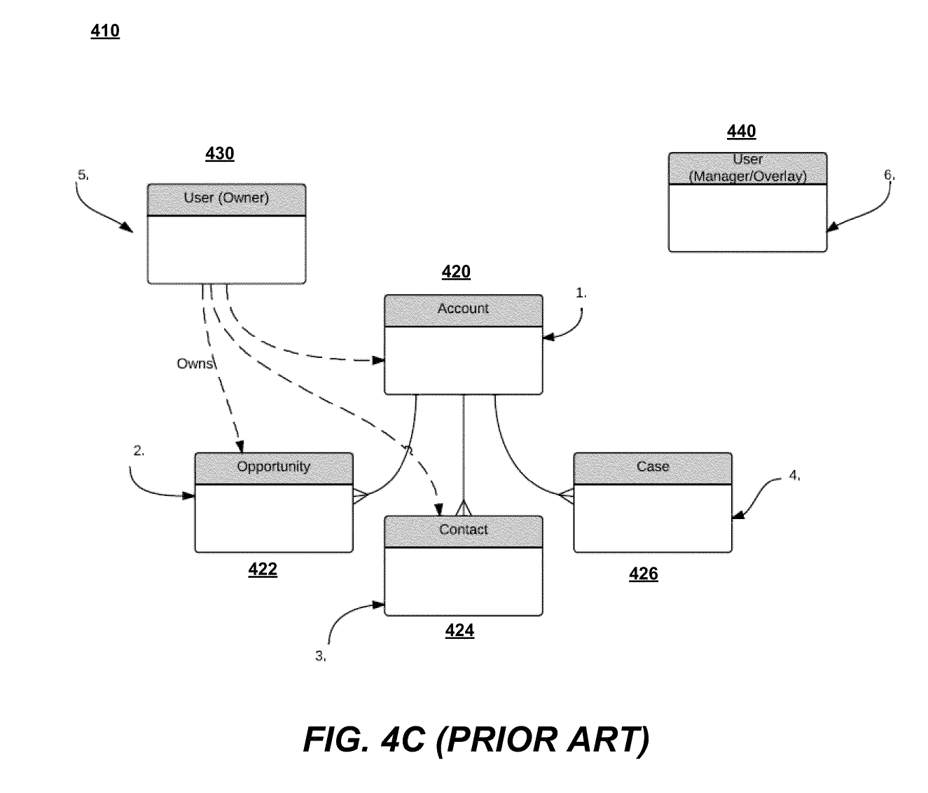

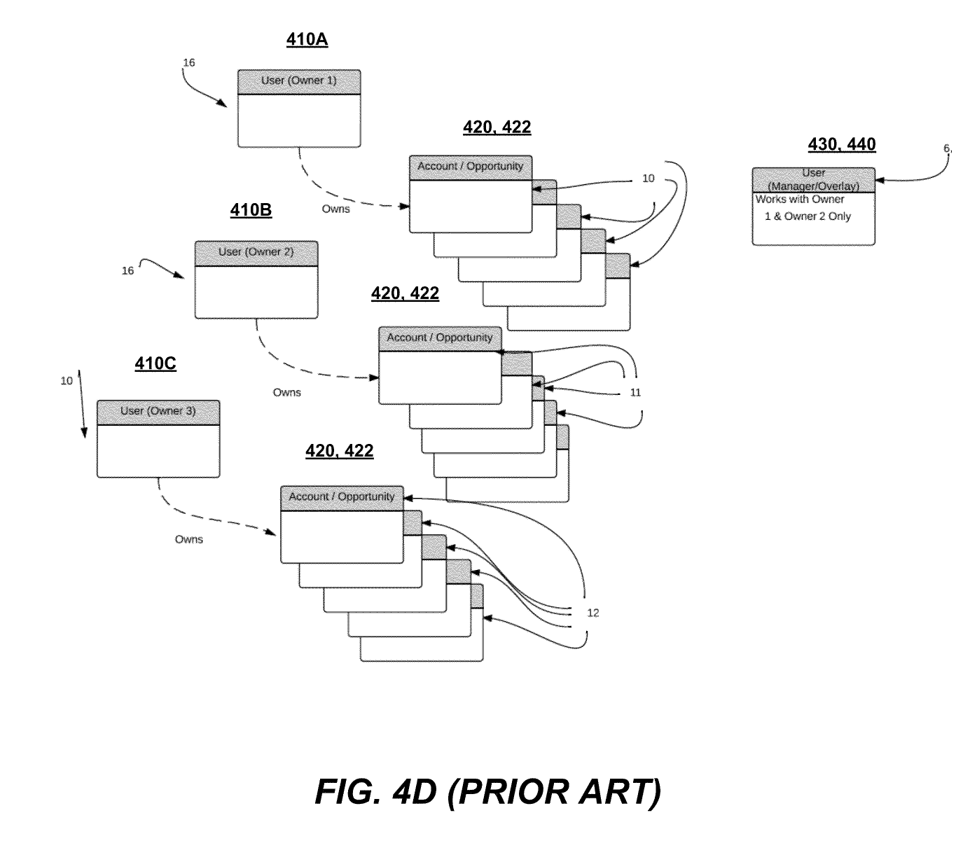

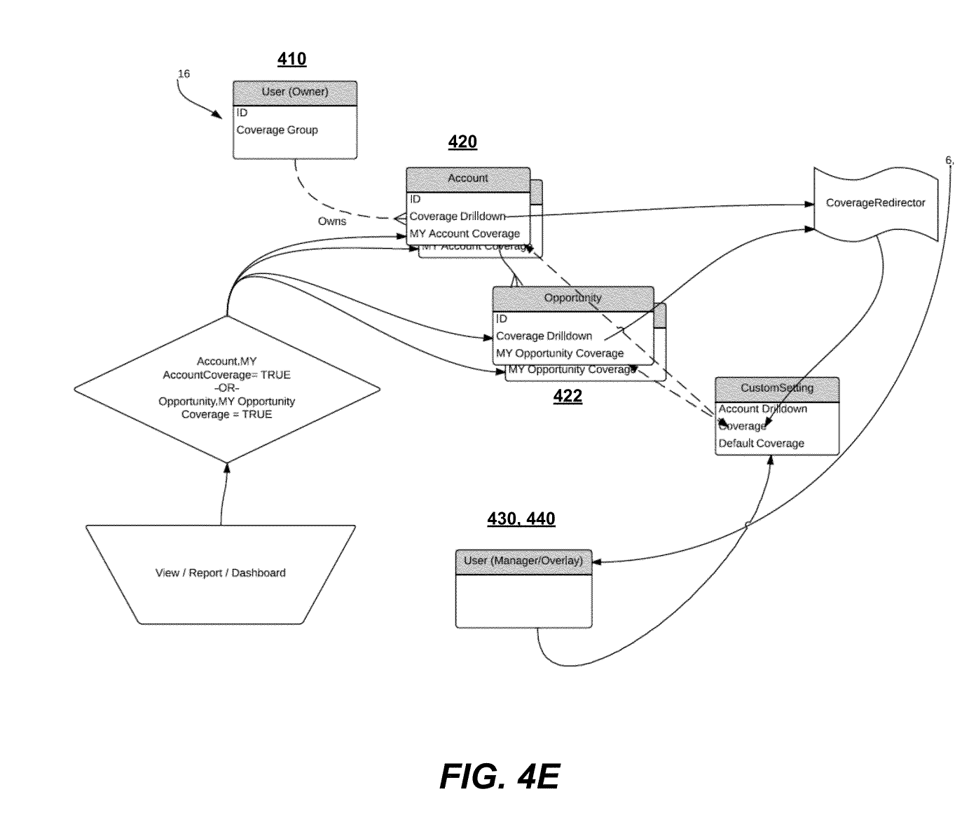

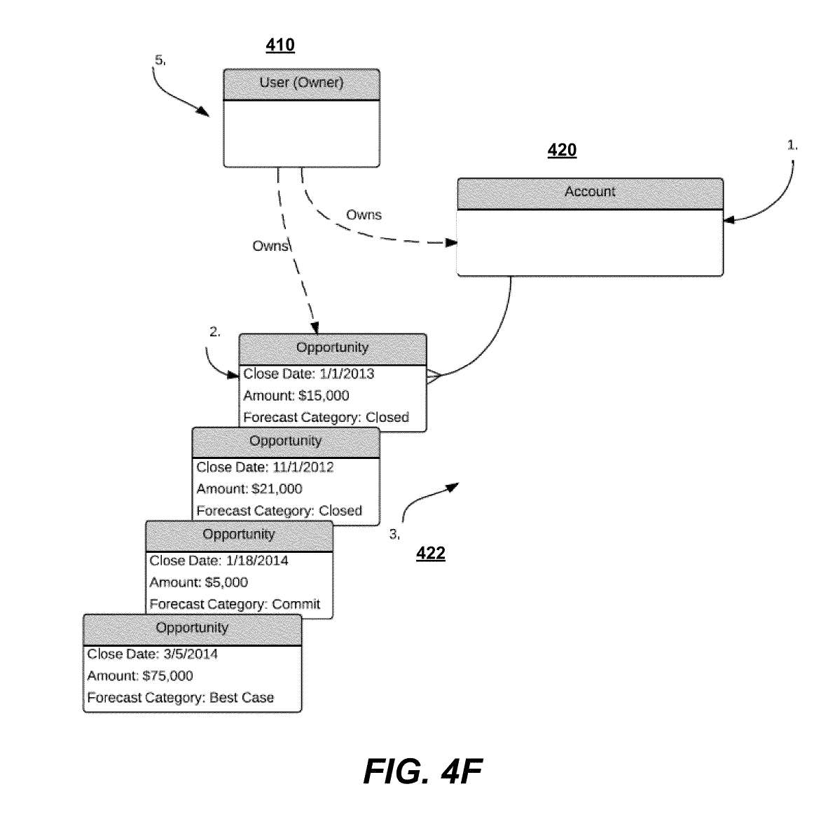

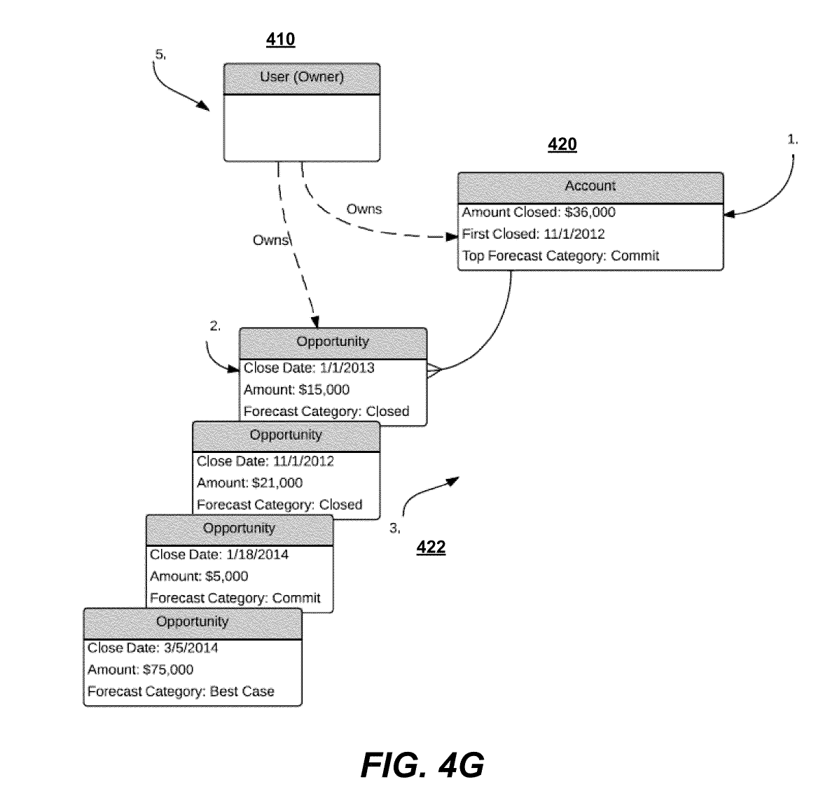

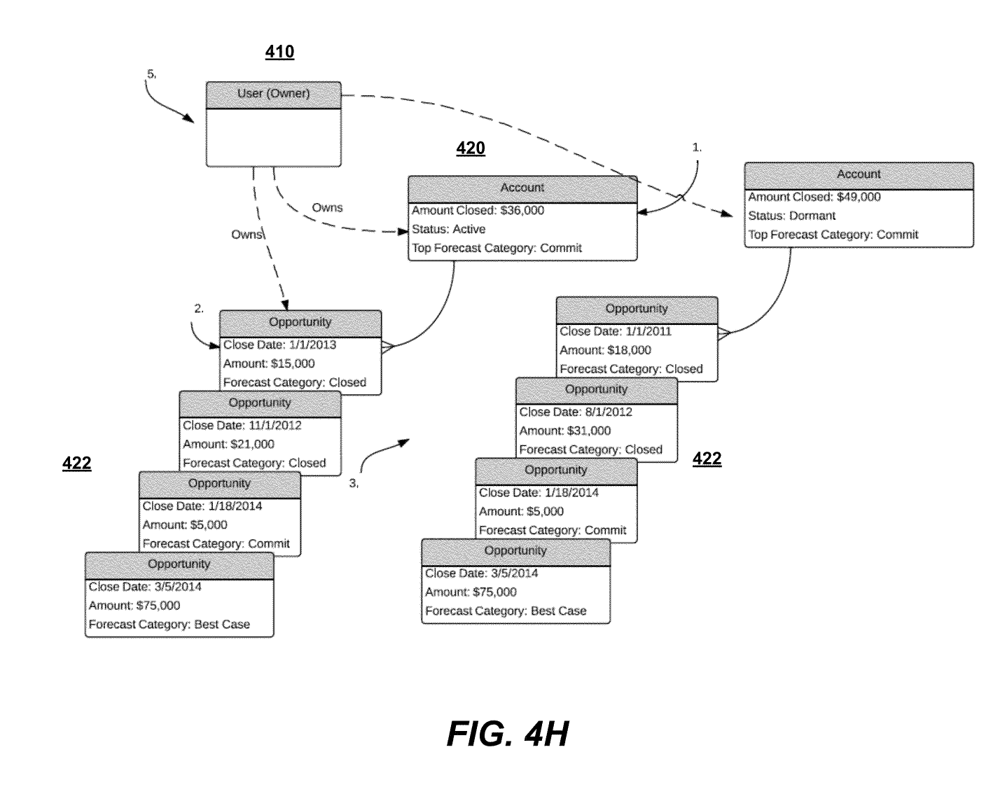

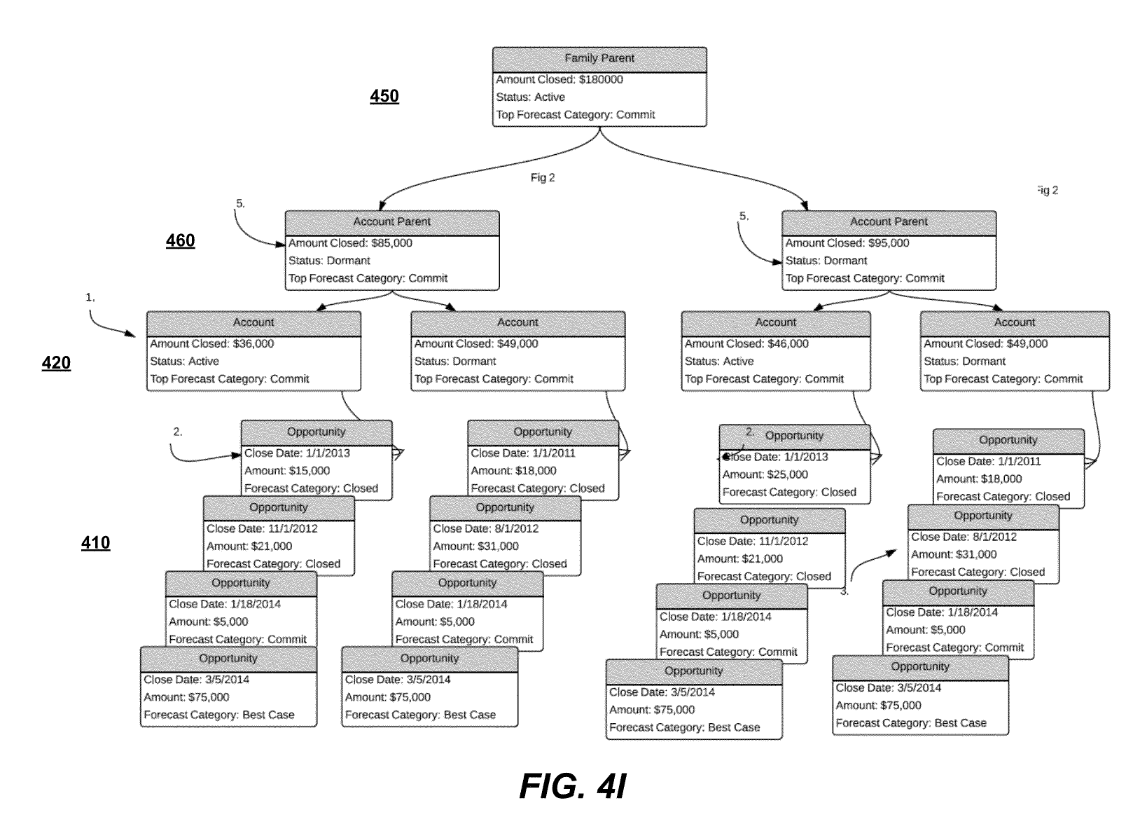

An example of limited traditional object relationships to an owner is shown in FIG. 4A, while FIG. 4B illustrates the personalization afforded under the techniques described herein for account drilldown through a coverage redirector. When looking at an account, the user can click an icon to trigger coverage redirector to update that user's custom setting to persist some data onto their custom setting that can be used to filter their access to see only the records they want to see and redirect the to a list of those records simultaneously.

In FIG. 4B, the field Account, MYAccountDrilldown is inherited from a parent object 420 to the child objects 422, 424, 426. The field MYAccountDrilldown is TRUE field 428 responsive to the account identification being in (i.e., has been written as updated personalization settings in response to a user selection) the AccountFocus field of the CustomSetting table 427.

Another example of limited traditional coverage for an overlay or a manager that does not own objects is shown in FIG. 4C (and objects of multiple owners shown in FIG. 4D), in contrast to FIG. 4E illustrating improved retrieval and filtering of data based on comparing the coverage group of the owner to the coverage setting of the user that is now available to be set by the coverage redirector. The manager (or overlay) can click on a custom attribute on an account or opportunity, the coverage redirector will adjust their custom setting and take them back to the same view or report that they are on, with the system using that custom setting as a key criteria that is compared to inherited groups on each object from the owner to filter visibility to meet personalization preferences.

In FIG. 4E, the account 420 and the opportunity 422 inherit the user identification and user's coverage group from a user default personalization settings 410. The field Account, MYAccountCoverage or Opportunity, MYOpportunity Coverage at 432 is TRUE when the object owner identification or coverage group is in (i.e., has been written as updated personalization settings in response to a user selection) the CustomSetting table 431 is in the Coverage or DefaultCoverage fields, respectively.

II. Methods for Dynamically Personalizing and Filtering Screens

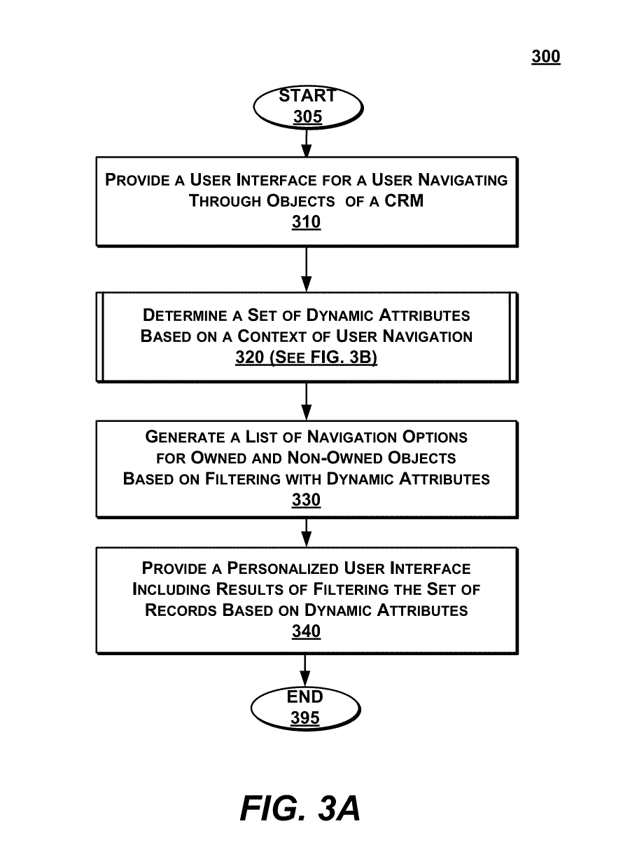

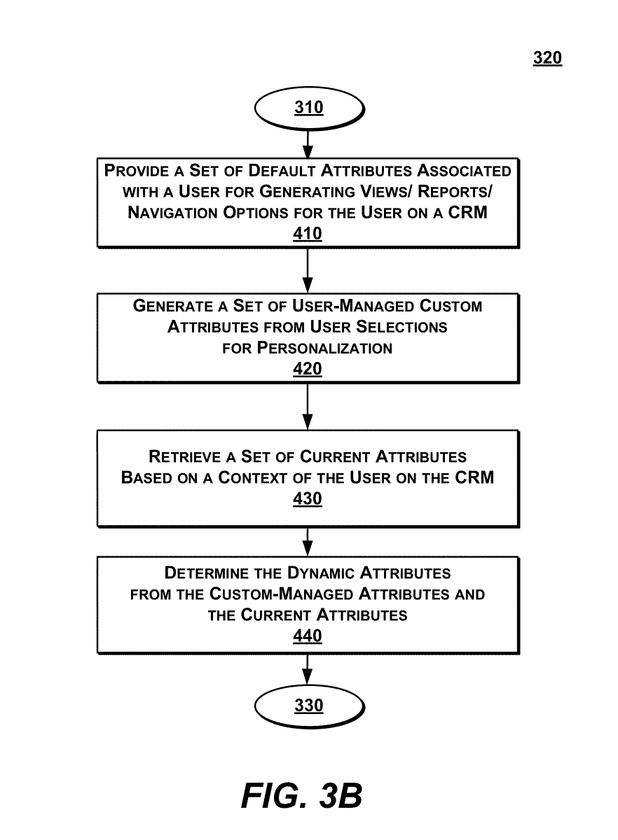

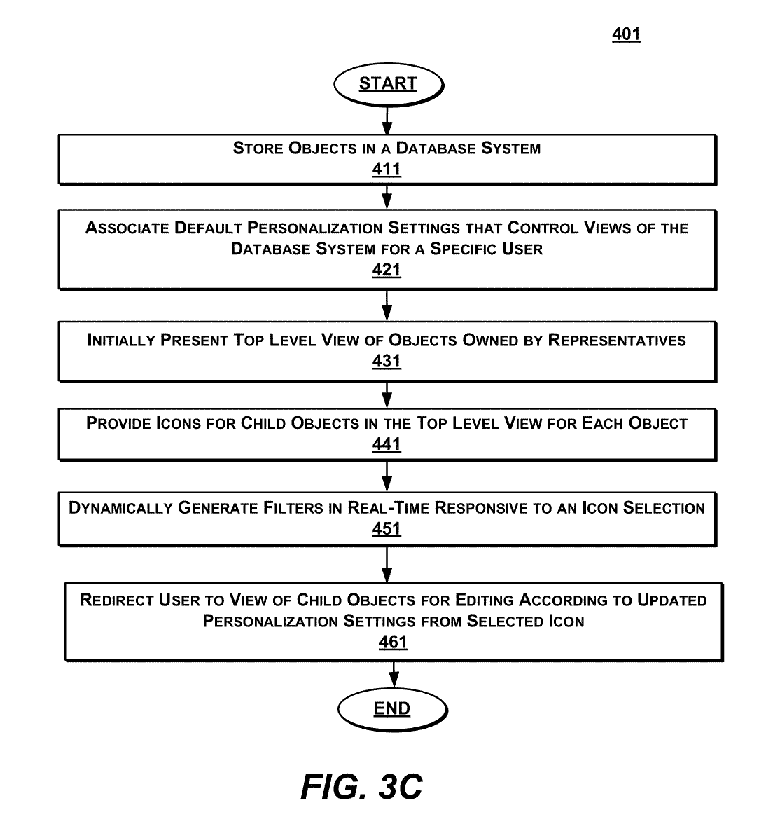

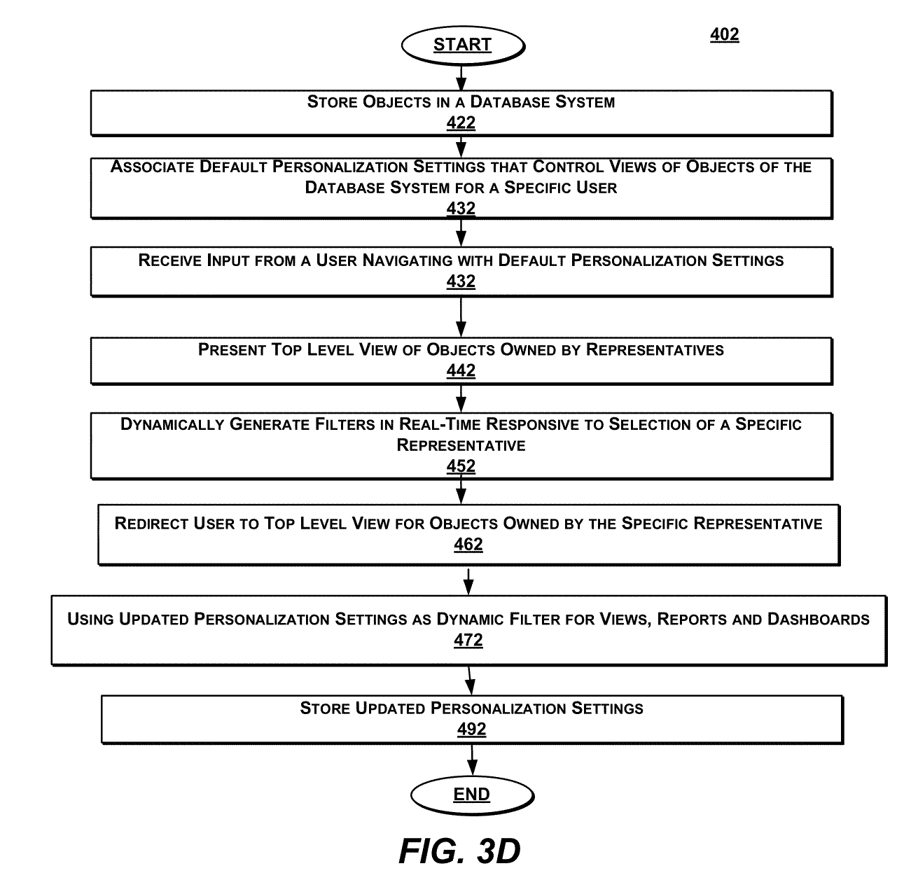

FIG. 3A is a high-level flow chart illustrating a method 300 for CRM personalization, according to one embodiment.

At step 310, a user interface is provided for a user navigating through objects of a CRM. For example, a sales manager can log on to an enterprise software system to view opportunities that his sales team is working on for new business with their key accounts. The objects each have a unique object identifier to be used for personalizing navigation in view a particular object (e.g., a certain representative, geography, or account cases). In some cases, an object represents an account and related child objects represent opportunities contacts and cases.

At step 320, a set of dynamic attributes is determined based on a context of user navigation (e.g., by a coverage redirector). In the sales example, the manager can access opportunities for a particular salesperson. The dynamic attributes can be associated with the responsible team member, the team they are on, the region they are in, the country they are in, or the like.

In one embodiment, the dynamic attributes are determined as detailed in FIG. 3B. At step 410, a set of grouping attributes is pre-set and associated with a user that owns objects (“owner”) in the CRM. At step 420, a user (“viewer”) can set a default value for their coverage preference for the collection of data they want to see based on the attributes set for each owner in step 410 for personalization. At step 430, the user can decide while navigating the system to instantly change from their default coverage preference to a specific active coverage preference to help them see only what they want to see in the system and back to their default coverage preference. At step 440 of FIG. 3B, the active personalization preference attributes of the user logged in are compared to the grouping attributes of the owner of each record being retrieved to determine whether to include each record in the result set for displaying to the user.

Another embodiment in FIG. 3C shows an exemplary method 401 for drill down techniques, according to one embodiment. At step 411, the set of objects is stored in a database. At step 421, responsive to a user logging on personalization settings that control views of the database for a user are associated with a session. At step 431, a top level view of objects is initially displayed to the user through a user interface. At step 441, icons are provided in the top level (or lower level) view for some or each of the objects on the screen. Icons represent a type of child objects, such as opportunities, cases or contacts. When an icon is selected, at step 451, a filter is dynamically generated in real-time. For example, a unique object identifier of the object is written to the personalization settings of the user. At step 461, a user is then redirected to a view of child objects related to the icon to allow editing. Child objects are filtered using the personalization settings of the database for the user.

Yet another embodiment in FIG. 3D shows an exemplary method 402 for coverage techniques, according to one embodiment. Drill down improvements can be advantageous when remotely logging on over a network that causes a delay with each extra click. At step 412, objects are stored as described herein. Responsive to a user logging in at step 422 default personalization settings are associated with the user. In operation, user input for navigating the system at step 432 uses default associations with one or more representatives from default personalization settings. A top level view of owned objects by default representatives is displayed at step 442. Responsive to receiving a selection of a specific representative, in some embodiments at step 452, a unique object identifier or attribute of the specific representative is written to active personalization settings of the user to replace or modify the default personalization settings. At step 462, a user is redirected to, for example, a top level view of objects associated with the specific representative, whether or not the objects are owned by the user. The updated personalization settings at step 492 are used as a dynamic filter for vies, reports and dash boards while navigation. At step 482, updated personalization settings are stored until another selection.

At step 330, a list of navigation options for owned and non-owned objects are generated based on filtering with dynamic attributes. Navigation options for the exemplary manager can be composed of objects owned by users whose coverage grouping matches the dynamic attributes the manager has set. In one instance objects include all opportunities owned by a rep on their team, all opportunities owned by anyone on their team, or the like.

At step 340, a personalized user interface is provided including results of filtering the set of records based on the dynamic attributes. Returning to the sales manager example, the manager can efficiently access information from the user interface without having to manually set their own filter criteria. They can also save the effort of multiple clicks and mental synthesis in navigating the user interface. In another case, the manager can get a list view allowing instant update capability and immediate navigation to another object (e.g., a peer sister or cousin object) rather than returning back up the node tree to the account in order to click back down to that next object for viewing. In an embodiment, inline editing allows data to be manipulated (e.g., added, deleted, updated, copied or saved) without opening the object screen to save time and effort for each update required.

III. General Computing Devices

Many of the functionalities described herein can be implemented with computer software, computer hardware, or a combination, as shown in FIG. 7.

The computing device 700 is an exemplary device that is implementable for each of the components of the system 100, including the wireless networking device 130. The computing device 700 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 700, of the present embodiment, includes a memory 710, a processor 720, a storage drive 730, and an I/O port 740. Each of the components is coupled for electronic communication via a bus 799. Communication can be digital and/or analog, and use any suitable protocol.

The memory 710 further comprises network applications 712 and an operating system 714. The network applications 712 can include a web browser, a mobile application, an application that uses networking, a remote application executing locally, a network protocol application, a network management application, a network routing application, or the like.

The operating system 714 can be one of the Microsoft Windows® family of operating systems (e.g., Windows 7, 8, Me, Windows NT, Windows 2000, Windows XP, Windows XP x64 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 720 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory 710 or the storage drive 730

The storage drive 730 can be any non-volatile type of storage such as a magnetic disc, EEPROM, Flash, or the like. The storage drive 730 stores code and data for applications.

The I/O port 740 further comprises a user interface 742 and a network interface 744. The user interface 742 can output to a display device and receive input from, for example, a keyboard. The network interface 744 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11 ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method for dynamically personalizing navigation and data filtering in a sales force automation database system that is remotely hosted on a data network and used by a plurality of personnel to manage account activities, comprising the steps of:
storing a plurality of objects, each object being owned by a representative and having a unique object identifier, each object representing an account and having related child objects to represent cases, opportunities and contacts associated with the account, the child objects being editable by navigating through screens from a top level to an object level, the object level including an editor;
responsive to logging in a user, associating default personalization settings that control views of the database system for the user;
initially presenting a top level view of the plurality of objects;
providing a set of icons, in the top level view, for each of the subset of the plurality of objects, each icon representing a type of child object;
responsive to receiving the selection of an icon from the set of icons presented that are associated with the object, dynamically generating a filter in real-time by writing a unique object identifier of the object to update the personalization settings of the user;
redirecting the user to a view of child objects of that object that allows edits of an attribute of the child objects, the child objects filtered according to the updated personalization settings; and
storing the updated personalization setting until another account is selected for inspection.

2. A computer-implemented method for dynamically personalizing navigation and data filtering for users in a salesforce automation database system that is remotely hosted on a data network and used by a plurality of personnel to manage account activities, comprising the steps of:
storing a plurality of objects, each object representing an account or opportunity and each object being owned by a representative responsible for the account or opportunity in at least one aspect, each object having several attributes of the account;
responsive to logging in a user, associating default personalization settings that control views of objects in the database system for the user;
receiving input from a user navigating the system who has a pre-configured default association with one or more representatives specified in the default personalization settings for that user;
presenting a top level view of the objects owned by that subset of the one or more representatives in accordance with the default personalization settings; and
responsive to receiving a selection of a specific representative, dynamically generating a filter in real-time by writing an object identifier or attribute of the specific representative to update the personalization settings of the user;
redirecting the user to a top level view of a subset of all objects owned by the specific representative, whether or not those objects are owned by the user;
using the updated personalization setting as a dynamic filter for views, reports, and dashboards; and
storing the updated personalization and the default personalization setting until a second specific user is selected for inspection.
